(19) United States
(12) Patent Application Publication
(10) Pub. No.: US 2020/0290277 A1
(43) Pub. Date: Sep. 17, 2020

(54) MODELING APPARATUS, METHOD, AND COMPUTER READABLE MEDIUM

(71) Applicant: Toshishige FUJII, Kanagawa (JP)

(72) Inventor: Toshishige FUJII, Kanagawa (JP)

(73) Assignee: Ricoh Company, Ltd., Tokyo (JP)

(21) Appl. No.: 16/805,968

(22) Filed: Mar. 2, 2020

(30) Foreign Application Priority Data
Mar. 13, 2019 (JP) 2019-046525

(51) Int. Cl. B29C 64/295; B29C 64/393; B29C 64/307

(52) U.S. Cl. CPC B29C 64/295; B33Y 30/00; B29C 64/307; B29C 64/393

(57) ABSTRACT

A modeling apparatus includes a modeling section, and a temperature distribution controller. The modeling section is configured to model a modeling layer with a modeling material on a modeling stage. The temperature distribution controller is configured to control a surface temperature distribution of the modeling stage within a predetermined temperature range associated with the modeling material based on the surface temperature distribution of the modeling stage.

### CROSS-REFERENCE TO RELATED APPLICATIONS

The present application claims priority under 35 U.S.C. § 119 to Japanese Patent Application No. 2019-046525, filed on Mar. 13, 2019. The contents of which are incorporated herein by reference in their entirety.

### BACKGROUND OF THE INVENTION

### 1. Field of the Invention

The present invention relates to a modeling apparatus, a method, and a computer readable medium.

### 2. Description of the Related Art

In recent years, as apparatuses for modeling a three-dimensional modeling object without using a mold or the like, three-dimensional (3D) printers have been widely used. Various apparatuses for modeling a three-dimensional modeling object have been proposed. For example, a three-dimensional modeling apparatus that uses thermoplastic resin to make a modeling material has been proposed (refer to, for example, Japanese Unexamined Patent Application Publication No. 2018-167405).

The three-dimensional apparatus described in Japanese Unexamined Patent Application Publication No. 2018-167405, however, cannot model a three-dimensional modeling object with bending and deformation being suppressed.

### SUMMARY OF THE INVENTION

According to an aspect of the present invention, a modeling apparatus includes a modeling section, and a temperature distribution controller. The modeling section is configured to model a modeling layer with a modeling material on a modeling stage. The temperature distribution controller is configured to control a surface temperature distribution of the modeling stage within a predetermined temperature range associated with the modeling material based on the surface temperature distribution of the modeling stage.

### BRIEF DESCRIPTION OF THE DRAWINGS

FIG. 1 is a schematic configuration diagram of a modeling apparatus according to an embodiment;

FIG. 2 is a block diagram illustrating a hardware configuration of the modeling apparatus;

FIG. 3 is a diagram illustrating the progress of bending;

FIG. 4 is a diagram illustrating the relation between a temperature of a surface of a modeling stage and ease of layer peeling;

FIG. 5 is a diagram illustrating optimal temperatures for modeling materials;

FIG. 6 is a process flowchart according to the embodiment;

FIG. 7 is a diagram illustrating the case where a temperature distribution of the surface of the modeling stage is controlled based on the temperature of a standard measurement point set at the center;

FIG. 8 is a diagram illustrating the case where the temperature distribution of the surface of the modeling stage is controlled based on temperatures of two standard measurement points set at the respective centers of two heaters forming a heater unit;

FIG. 9 is a diagram illustrating the case where heaters according to a second example are used to control the temperature distribution of the surface of the modeling stage based on the temperature of a single standard measurement point set at a central portion of the modeling stage;

FIG. 10 is a diagram illustrating the case where the heaters according to the second example are used to control the temperature distribution of the surface of the modeling stage based on temperatures of a plurality of standard measurement points set at respective central portions of the heaters; and

FIG. 11 is a diagram illustrating the case where heaters according to a first example are used to control the temperature distribution of the surface of the modeling stage based on the temperature of the single measurement point set at the central portion of the modeling stage.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to obtain a high-quality three-dimensional modeling object using a simple configuration while suppressing bending and deformation of the three-dimensional modeling object.

Hereinafter, a modeling apparatus according to an embodiment is described in detail with reference to the accompanying drawings. The invention, however, is not limited by the embodiment.

As an example of the modeling apparatus, fused deposition modeling is described. In the fused deposition modeling, a modeling layer is formed by thermally melting a modeling material containing thermoplastic resin into a semiliquid and discharging the modeling material to a predetermined position based on 3D data of a three-dimensional modeling object to be modeled. The three-dimensional modeling object can be more easily modeled by repeatedly performing this modeling layer stacking, compared with other methods.

For the modeling material used in the fused deposition modeling, for example, a modeling material obtained by stacking a core layer of resin and a sheath layer of super engineering plastic such as polyetheretherketone can be used. The resin is difficult to handle in the making or storing of the modeling material or manufacturing of the three-dimensional modeling object.

Hereinafter, an embodiment of the invention is described with reference to the accompanying drawings.

### Entire Configuration

The following describes a modeling apparatus according to the embodiment that includes a modeling section that models a modeling layer with a modeling material on a modeling stage, the modeling apparatus modeling a three-dimensional modeling object in the fused deposition modeling using thermoplastic resin.

The modeling apparatus is not limited to an apparatus using the fused deposition modeling and is applicable to various modeling methods. As the modeling apparatus, any desired modeling apparatus that models a modeling object (three-dimensional modeling object) on a placement surface of a modeling stage can be used.

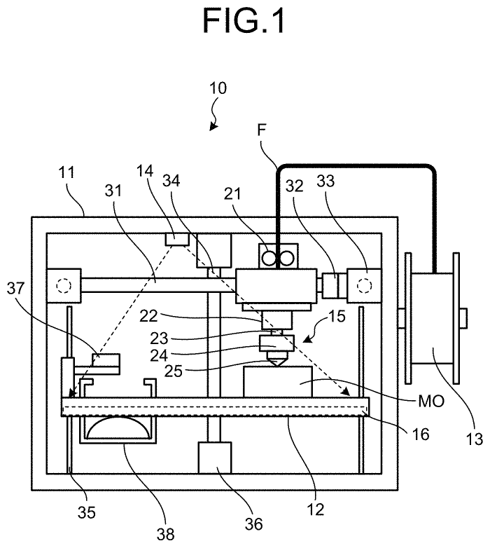

FIG. 1 is a schematic diagram of the modeling apparatus according to the embodiment.

The modeling apparatus 10 includes a casing 11, a modeling stage 12, a reel 13, a thermography camera 14 serving as a surface temperature distribution measurer, a discharging module 15 serving as a modeling section, and a heater unit 16 serving as a heating section.

A processing space for modeling a three-dimensional modeling object MO is present in the casing 11 of the modeling apparatus 10.

In the processing space of the casing 11, the modeling stage 12 is installed and the three-dimensional modeling object MO is modeled on the modeling stage 12. A surface of the modeling stage 12 serves as an interface between the three-dimensional modeling object MO and the modeling stage 12. The three-dimensional modeling object MO may be largely bent due to a difference between a temperature of the three-dimensional modeling object MO and a temperature of the modeling stage 12.

The modeling stage 12 has the surface that is as flat as possible and can be set so that the surface extends in a horizontal direction to model a material on the surface of the modeling stage 12. As a material of the modeling stage 12, any desired material that is metal such as aluminum (Al) or stainless, resin, glass, or the like may be used as long as the foregoing object is achieved. It is, however, necessary that a modeling material be in close contact with the surface without being bent and deformed. To complement this function, coating or the like is conducted. As the coating, polyamideimide, dried paste, resin, or the like is selected based on its use. In this case, when the material of the modeling stage 12 or a coating material is changed, an optimal surface temperature for the modeling material to be actually modeled may change, and attention should be paid to the change.

A long filament F is wrapped around the reel 13 so as to be pullable out of the reel 13. The filament F is used as the modeling material to model the three-dimensional modeling object MO and includes a resin composition containing thermoplastic resin as a matrix. The filament F is a long, thin, solid material formed in a wire shape.

The thermography camera 14 measures a surface temperature distribution of the modeling stage 12. The thermography camera 14 is installed above the modeling stage 12 in the casing 11. To detect temperature of the surface of the modeling stage 12, the thermography camera 14 images the modeling stage 12, analyzes an infrared ray emitted from an object without contacting the object, converts radiance of the infrared ray to temperature, and displays a heat distribution as an image.

The discharging module 15 includes an extruder 21, a cooling block 22, a filament guide 23, a heating block 24, and discharging nozzles 25.

In the foregoing configuration, the filament F wrapped around the reel 13 is pulled due to the rotation of the extruder 21 (section for driving the filament F) constituting the discharging module 15, and the extruder 21 rotates without causing large resistance and supplies the filament F. Specifically, the filament F is pulled by the extruder 21 and supplied to the discharging module 15 of the modeling apparatus 10.

The cooling block 22 cools the filament F. The cooling block 22 is installed above the heating block 24. In this case, the cooling block 22 includes a cooling source that cools the filament F. Thus, the cooling block 22 prevents the filament F from flowing backward toward an upper portion of the discharging module 15, prevents resistance to extrusion of the melted filament F from increasing, or prevents a transport path from being clogged due to the solidification of the melted filament F.

The filament guide 23 is configured to guide the filament F to be supplied and is installed between the cooling block 22 and the heating block 24.

The heating block 24 heats the filament F. The heating block 24 includes a heater serving as a heat source and a thermocouple for detecting a temperature to control the heater. The heating block 24 heats and melts the filament F supplied to the discharging module 15 through the transport path and supplies the filament F to the discharging nozzles 25.

The discharging nozzles 25 discharge the filament F. The discharging nozzles 25 are installed at a lower end of the discharging module 15. The discharging nozzles 25 push out and discharge, onto the modeling stage 12, the melted or semi-melted filament F supplied from the heating block 24 so that the discharged filament F is in a linear shape. The discharged filament F is cooled and solidified to form a layer in a predetermined shape. The discharging nozzles 25 repeat an operation of pushing out and discharging the melted or semi-melted filament F in a linear shape onto a formed layer, thereby stacking a new layer on the formed layer. By performing this operation, the modeling apparatus 1 models the three-dimensional modeling object MO.

In the embodiment, the two discharging nozzles 25 are installed in the discharging module 15. The first discharging nozzle 25 melts and discharges a filament F of a model material that forms the three-dimensional modeling object MO. The second discharging nozzle 25 melts and discharges a filament F of a supporting material that supports the model material. In FIG. 1, the second discharging nozzle 25 is installed on the back side of the first discharging nozzle 25. The number of discharging nozzles is not limited to 2 and may be selected based on a purpose.

A supporting portion formed of the supporting material discharged from the second discharging nozzle is finally removed from a model portion formed of the model material. In the embodiment, the supporting material is different from the model material forming the three-dimensional modeling object MO, but may be the same as the model material.

The filament F of the model material and the filament F of the supporting material are melted by the heating block 24, pushed out and discharged from the discharging nozzles 25, and sequentially stacked to form a layer.

The discharging module 15 and a heating module 20 are held by and movable relative to an X axis driving shaft 31 (extending in an X axis direction) extending in a left-right direction (left-right direction in FIG. 1) of the apparatus via a coupling member. The discharging module 15 can be moved by driving force of an X axis driving motor 32 in the left-right direction (X axis direction) of the apparatus.

The X axis driving motor 32 is held by and movable along a Y axis driving shaft (extending in a Y axis direction) extending in a front-back direction (depth direction in FIG. 1). By moving the X axis driving shaft 31 along with X axis driving motor 32 by means of driving force of a Y axis driving motor 33 in the Y axis direction, the discharging module 15 and the heating module 20 are moved in the Y axis direction.

A Z axis driving shaft 34 and a guide shaft 35 extend through the modeling stage 12. The modeling stage 12 is held by and movable along the Z axis driving shaft 34 extending in a top-bottom direction (top-bottom direction in FIG. 1) of the apparatus. The modeling stage 12 is moved by driving force of a Z axis driving motor 36 in the top-bottom direction (Z axis direction) of the apparatus. The modeling stage 12 may include a modeling object heating section that heats a modeling object placed on the modeling stage 12. It is sufficient if the modeling stage 12 and the discharging module 15 move relative to each other. While the discharging module 15 may be fixed, the modeling stage 12 may be moved in the X and Y axis directions. While the modeling stage 12 may be fixed, the discharging module 15 may be driven to move in the Z axis direction.

When the filament F is continuously melted and discharged over time, a portion that is present near the discharging nozzles 25 may get dirty with the melted filament F or the like. Thus, a cleaning brush 37 that is included in the modeling apparatus 1 periodically performs an operation of cleaning the portion near the discharging nozzles 25, so as to prevent the filament F from adhering to ends of the discharging nozzles 25.

From the perspective of the prevention of the adhesion, it is preferable that the cleaning operation be performed before the temperature of the melted filament F drops completely. In this case, it is preferable that the cleaning brush 37 be made of a heat-resistant member.

In addition, abrasive powder generated in the cleaning operation may be collected in a dust box 38 included in the modeling apparatus 1 and may be periodically discarded. Alternatively, a suction path may be installed and the abrasive powder may be discharged to the outside of the modeling apparatus 1 via the suction path.

The heater unit 16 heats the modeling stage 12. The heater unit 16 is installed in the modeling stage 12 and includes a plurality of planar heaters.

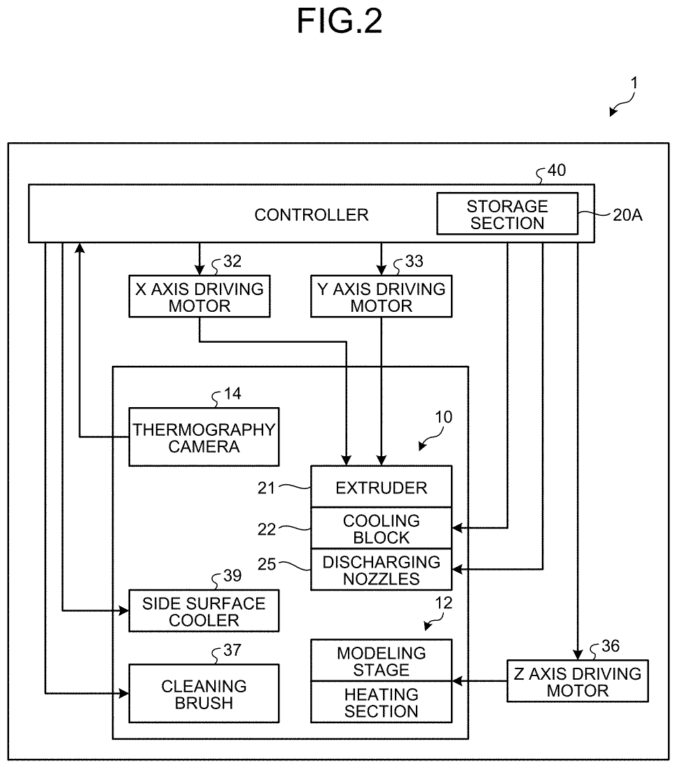

FIG. 2 is a block diagram illustrating a hardware configuration of the modeling apparatus. Configurations indicated by the same reference signs as those illustrated in FIG. 1 will not be described below.

The modeling apparatus 10 includes a controller 40. The controller 40 is configured as what is called a microcomputer including an MPU, a memory, and various circuits and is electrically connected to sections illustrated in FIG. 2.

The modeling apparatus 10 includes an X axis coordinate detecting mechanism for detecting an X-directional position of the discharging module 15. The detection result of the X axis coordinate detecting mechanism is transmitted to the controller 40. The controller 40 controls driving of the X axis driving motor 32 based on the detection result to move the discharging module 15 or the discharging nozzles 25 to a target X-directional position.

The modeling apparatus 10 also includes a Y axis coordinate detecting mechanism for detecting a Y-directional position of the discharging module 15. The detection result of the Y axis coordinate detecting mechanism is transmitted to the controller 40. The controller 40 controls driving of the Y axis driving motor 33 based on the detection result to move the discharging module 15 or the discharging nozzles 25 to a target Y-directional position.

The modeling apparatus 10 includes a Z axis coordinate detecting mechanism for detecting a Z-directional position of the modeling stage 12. The detection result of the Z axis coordinate detecting mechanism is transmitted to the controller 40. The controller 40 controls driving of the Z axis driving motor 36 based on the detection result to move the modeling stage 12 to a target Z-directional position.

In this manner, the controller 40 controls the movement of the discharging module 15 and the movement of the modeling stage 12 to three-dimensionally move the discharging module 15 and the modeling stage 12 relative to each other and position the discharging module 15 and the modeling stage 12 at target three-dimensional positions.

In addition, the controller 40 outputs control signals to driving sections for the extruder 21, the cooling block 22, the discharging nozzles 25, and the cleaning brush 37 to control driving of the extruder 21, the cooling block 22, the discharging nozzles 25, and the cleaning brush 37.

The modeling apparatus 10 according to the embodiment includes at least a layer modeling section for discharging resin as the modeling material and modeling a modeling layer.

Principles of the embodiment are described below.

When a traditional modeling material, for example, a modeling material such as polyetheretherketone (PEEK) is used, a three-dimensional modeling object may be largely bent in the middle of the modeling of the three-dimensional modeling object and may not be appropriately modeled.

Especially, when resin with a high melting temperature, such as PEEK that is called super engineering plastic, is used as the modeling material (filament F), the difference between the melting temperature and a modeling environment temperature is large. Therefore, the three-dimensional modeling object MO may be easily largely deformed in the middle of the modeling.

In addition, when the three-dimensional modeling object is modeled using super engineering plastic, the three-dimensional modeling object becomes bent and peels off from the modeling stage in the middle of the modeling and cannot be modeled. These problems are noticeable when a large three-dimensional modeling object is modeled.

Therefore, the modeling apparatus 10 according to the embodiment uses the thermography camera 14 to measure a temperature distribution of the modeling stage 12 upon the heating by the heater unit 16.

Then, the controller 40 serves as a temperature distribution controller and controls the surface temperature distribution of the modeling stage within a predetermined temperature range associated with the modeling material based on the surface temperature distribution measured by the thermography camera 14. Specifically, the controller 40 individually controls a temperature of each of the planar heaters forming the heater unit 16. The controller 40 performs, based on the surface temperature distribution from the thermography camera 14, feedback control on the heaters forming the heater unit 16 so that temperature of the surface of the modeling stage 12 is as uniform as possible.

As a result, it is possible to optimize a temperature of the stage surface that is the interface, which highly contributes to the cause of bending, between the modeling stage and the modeling object, and to significantly suppress the occurrence of bending of a bottom surface of a modeling object that may become bent with the highest probability.

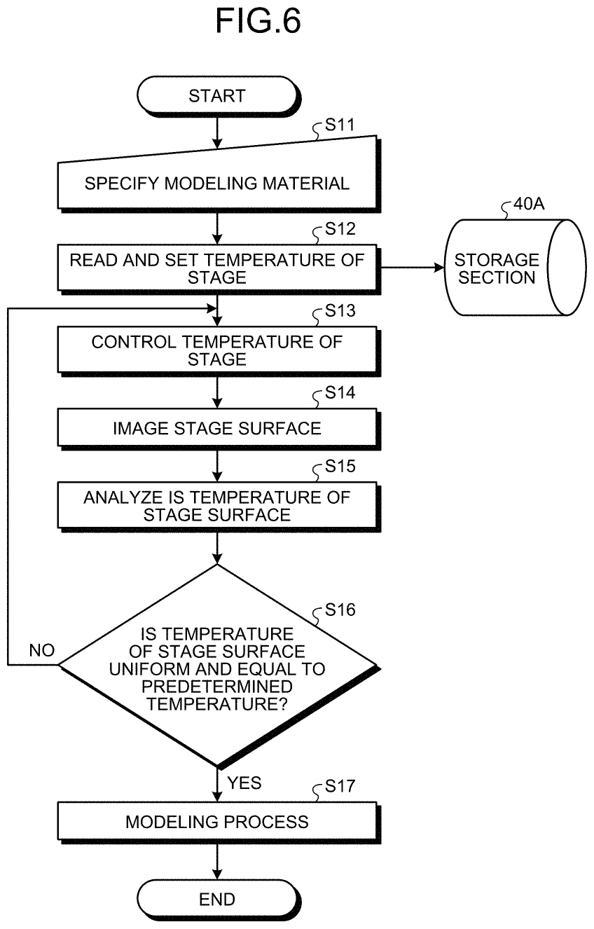

FIG. 6 is a process flowchart according to the embodiment.

A method for controlling a temperature of the surface of the modeling stage 12 is performed in the following procedure.

First, an operator specifies a modeling material (at step S11).

Subsequently, the controller 40 reads a temperature, which is associated with the specified modeling material, of the modeling stage 12 from a storage section 40A of the controller 40 and sets the temperature (at step S12).

Next, the controller 40 controls the heater unit 16 and controls temperature of the surface of the modeling stage 12 (at step S13).

Subsequently, the controller 40 controls the thermography camera 14 to cause the thermography camera 14 to image the surface of the modeling stage 12 (at step S14) and measure and analyze temperature, including the temperature of a standard measurement point, of the surface of the modeling stage 12 (at step S15).

Next, the controller 40 determines whether the temperature of the surface of the modeling stage 12 is uniform and equal to a predetermined temperature (at step S16).

In the determination of step S16, the controller 40 determines whether a temperature of the surface of the modeling stage 12 deviates from the surface temperature, set at step S12, of the modeling stage 12. When the temperature of the surface is yet neither uniform nor equal to the predetermined temperature (No at step S16), the controller 40 causes the process to proceed to step S13 to repeatedly perform the foregoing processes and control the temperature of the surface of the modeling stage 12.

In a normal operation of the modeling apparatus 10, in the determination of step S16, the controller 40 determines whether a temperature of the surface of the modeling stage 12 deviates from the surface temperature, set at step S12, of the modeling stage 12. When the controller 40 determines that the temperature of the surface is uniform and equal to the predetermined temperature (Yes at step S16), the controller 40 proceeds the process to a modeling process (at step S17).

As the modeling material used in the embodiment, a resin material containing light-curable resin is used. Especially, thermoplastic resin is suitable as the modeling material used in the embodiment. The modeling material, however, is not limited and may be selected based on a purpose and may contain another component as long as the temperature of the surface of the modeling stage needs to be managed for the modeling material. The modeling material may be separated into the model material that finally forms the three-dimensional modeling object, and the supporting material that serves as the supporting portion for supporting the model portion formed of the model material in the modeling. As described above, the modeling materials may be discharged from different discharge ports of a layer forming section.

The thermoplastic resin used as the modeling material is not limited and may be selected based on the purpose. Examples of the thermoplastic resin include crystalline resin, non-crystalline resin, and liquid crystal resin.

The crystalline resin is resin with a melting point peak that is detected in measurement conforming to ISO3146 (method for measuring a plastic transition temperature, JIS K7121).

Examples of the thermoplastic resin used by the modeling apparatus are ABS, ASA, polycarbonate (PC), nylon 12, polyolefin, polyamide, polyester, polyether, polyphenylene sulfide, and polyacetal (polyoxymethylene (POM)). One type of these substances may be used independently, or two or more types of these substances may be used, like PC-ABS.

Examples of polyolefin include polyethylene (PE) and polypropylene (PP).

Examples of polyamide include polyamide 410 (PA410), polyamide 6 (PA6), polyamide 66 (PA66), polyamide 610 (PA610), polyamide 612 (PA612), polyamide 11 (PA11), polyamide 12 (PA12), and semi-aromatic polyamide such as polyamide 4T (PA4T), polyamide MXD6 (PAMXD6), polyamide 6T (PA6T), polyamide 9T (PA9T), and polyamide 10T (PA10T).

Examples of polyester include polyethylene terephthalate (PET), polybutadiene terephthalate (PBT), and a polylactic acid (PLA). Among these substances, an aromatic substance containing a terephthalic acid or an isophthalic acid is preferably used. This is because the aromatic substance is heat-resistant.

Examples of polyether include polyarylketone and polyether sulfone.

Examples of polyarylketone include polyetheretherketone (PEEK), polyetherketone (PEK), polyetherketoneketone (PEKK), polyaryletherketone (PAEK), polyetheretherketoneketone (PEEKK), and polyetherketoneetherketoneketone (PEKEKK).

As the thermoplastic resin, for example, a substance with two melting point peaks, such as PA9T (polyamide resin), may be used. When the temperature of thermoplastic resin with two melting point peaks is equal to or higher than a higher one of the two melting point peaks, the thermoplastic resin is completely melted.

Polyphenylene sulfide (with a coefficient of linear expansion of 4.9×10⁻⁵/° C.), polysulfone (with a coefficient of linear expansion of 5.6×10⁻⁵/° C.), polyether sulfone (with a coefficient of linear expansion of 5.6×10⁻⁵/° C.), polyetherimide (with a coefficient of linear expansion of 4.7×10⁻⁵/° C.), polyamideimide (with a coefficient of linear expansion of 3.1×10⁻⁵/° C.), polyetheretherketone (with a coefficient of linear expansion of 4.7×10⁻⁵/° C.), polyphenyl sulfone (with a coefficient of linear expansion of 5.6×10⁻⁵/° C.), and the like are referred to as “super engineering plastic (super-enpla)”.

Each of the foregoing coefficients of linear expansion expresses a coefficient of expansion due to a rise in temperature in a length of an object per degree in temperature. When general thermoplastic resin is exemplified for comparison, coefficients of linear expansion are as follows.

Polyvinyl chloride (7×10⁻⁵/° C. to 25×10⁻⁵/° C.), Polyethylene (5.9×10⁻⁵/° C. to 11×10⁻⁵/° C.), Polypropylene (8.1×10⁻⁵/° C. to 10×10⁻⁵/° C.), ABS (6.5×10⁻⁵/° C. to 9.5×10⁻⁵/° C.), Nylon 12 (10×10⁻⁵/° C.)

In the foregoing comparison, the above-described pieces of super engineering plastic tend to have the lower coefficients of linear expansion than the general thermoplastic resin. Originally, the super engineering plastic has very high melting temperature and small coefficients of linear expansion. Thus, despite the fact that the amounts of the distortions and the bending are large due to a difference between the melting temperature and the modeling environment temperature, it is possible to perform three-dimensional modeling on the super engineering plastic while suppressing the bending and the distortions.

Although the invention is effective for the general thermoplastic resin, it is preferable that the thermoplastic resin be of at least one type selected from among the super engineer plastic such as polyphenylene sulfide, polysulfone, polyether sulfone, polyetherimide, polyamideimide, polyetheretherketone, and polyphenyl sulfone. When the thermoplastic resin is super engineering plastic, tensile strength, heat resistance, chemical resistance, and flame resistance of the three-dimensional modeling object to be modeled can be improved, the three-dimensional modeling object can be used for an industrial application, and thus the super engineering plastic is advantageous in terms of the foregoing features.

Other components are not limited and may be selected for the purpose.

### EXAMPLES

Although the invention is described below in detail by illustrating examples and a comparative example, the invention is not limited by the examples.

Preliminary Experiment

First, results of a preliminary experiment that led to the invention are described before description of the examples and the comparative example.

The modeling apparatus 10 was used to model a sample for bending evaluation. Specifically, temperature of the discharging nozzles 25 of the discharging module 15 was 400° C., a line width of the filament F to be discharged was 0.5 mm, a speed at which the discharging module 15 is scanned was 100 mm/s, a build plate temperature of the modeling stage 12 was set to a range of 135° C. to 200° C., and a filament F of a polyetheretherketone (PEEK) (450G grade, made by Victrex, with a viscosity of 450 Pa·s at 400° C. and a coefficient of linear expansion of 4.7×10⁻⁵/° C.) material as the thermoplastic resin was discharged from the discharging module 15 to form the sample. In this case, the material of the modeling stage 12 was aluminum (Al), and the surface of the modeling stage 12 was coated with polyimide.

The test piece for the bending evaluation was a solid structure with a size of 50 mm×50 mm×10 mm. By repeatedly alternately discharging the filament F only in the Y axis direction for odd-number layers and only in the X axis direction for even-number layers, 50 layers, each having a thickness of 2 mm, were stacked to form the test piece.

As described above, super engineering plastic such as PEEK has a high melting temperature that is largely different from the modeling environment temperature. It is therefore known that when the modeling stage is heated at an inappropriate temperature, the super engineer plastic becomes largely bent.

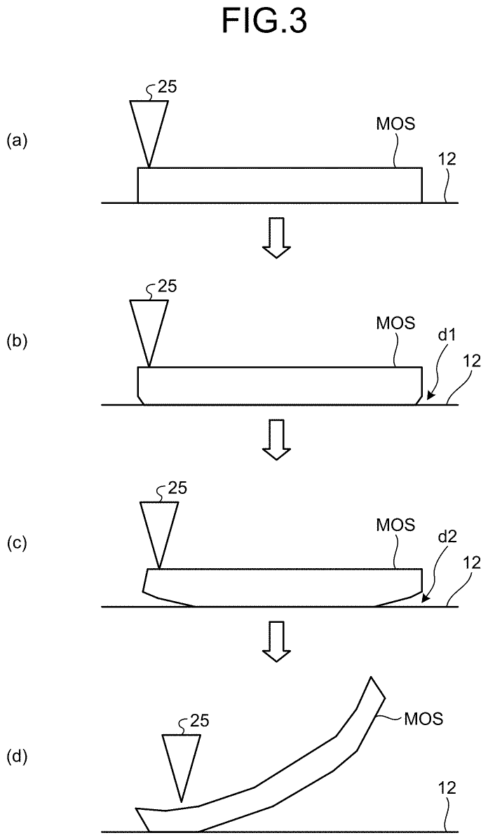

FIG. 3 is a diagram illustrating the progress of bending.

For example, when a requirement for the modeling stage is not satisfied, the test piece MOS adheres to the modeling stage 12 in an initial state, as illustrated at (a) in FIG. 3.

When a stacking process is progressed, an end portion begins to peel off from the modeling stage 12 and a gap dl is formed at an outer end portion of the test piece MOS, as illustrated at (b) in FIG. 3.

When the stacking process is further progressed, the test piece MOS becomes bent upward and a larger gap d2 is formed at the outer end portion of the test piece MOS, as illustrated at (c) in FIG. 3.

Then, the amount of the bending of the test piece MOS gradually increases and the test piece MOS finally peels off from the modeling stage 12, as illustrated at (d) in FIG. 3.

Next, the relation between a temperature of the surface of the modeling stage 12 and ease of the peeling are described.

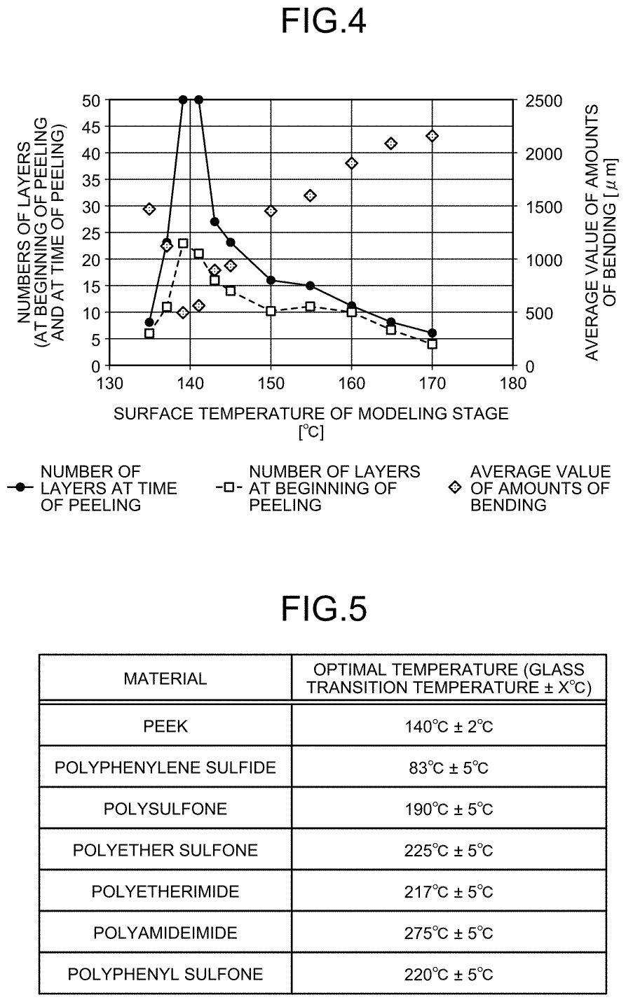

FIG. 4 is a diagram illustrating the relation between the temperature of the surface of the modeling stage 12 and the ease of the layer peeling.

In FIG. 4, temperature of the surface of the modeling stage 12 is finely set. FIG. 4 indicates, in modeling at each of the temperatures of the surface, the number of layers when the test piece MOS begins to peel off in the modeling and the number of layers when the test piece MOS peels off in the modeling.

In the evaluation, the temperature of the surface was measured by a contact-type thermometer (ANRITSU HD-1100K digital thermometer). In this evaluation, it is possible to know adhesion to the modeling stage 12 the test piece MOS has, based on the difference between the number of layers at beginning of bending and the number of layers at peeling off.

In addition, FIG. 4 illustrates the amount of bending of a bottom surface (contact surface with the modeling stage 12) of the modeling object. The amount of the bending indicates an average value of differences, which are measured by a vertical stylus meter (Mitutoyo digital height gauge), between a vertical position of a central portion of the test piece and vertical positions of four corners of the test piece in a state in which the test piece is turned over.

As illustrated in FIG. 4, an optimal range of the temperature of the surface of the modeling stage 12 on which up to 50 layers with the solid structure can be modeled was very small and was a range of several ° C. When the temperature of the surface deviated from the optimal temperature by only 5° C., the amount of the bending increased and the test piece peeled off in the middle of the stacking of the 50 layers of the test piece. Specifically, it was found that it was necessary to accurately set the temperature of the modeling stage 12 (to the optimal temperature±several ° C.).

FIG. 5 is a diagram illustrating optimal temperatures for modeling materials.

For example, it was found that an optimal temperature for PEEK was in a range of a grass transition temperature of 140° C.±2° C.

In addition, it was found that each of optimal temperatures for polyphenylene sulfide, polysulfone, polyether sulfone, polyetherimide, polyamideimide, and polyphenyl sulfone was in a range of a grass transition temperature ±5° C.

For example, it was found that an optimal temperature for polyether sulfone was in a range of a glass transition temperature of 225° C.±5° C.

Data of the foregoing optimal temperature is stored in the storage section 40A of the controller 40.

### First Example

Next, a first example is described.

From the foregoing preliminary experiment, it was found that it was necessary to strictly manage the temperature of the surface of the modeling stage. The temperature of the modeling stage, however, is normally managed using the thermocouple embedded in the stage. In this case, however, the temperature of the entire surface of the modeling stage cannot be managed within a range of several ° C. In addition, every time the modeling is performed, it takes a lot of efforts with the contact-type thermometer used in the experiment. Especially for a large-area modeling stage, it is necessary to evaluate temperatures of many points.

Therefore, in the first example, temperature of a surface of the large-area modeling stage was measured by the thermography camera 14.

The Optris PI450 thermal imaging camera was used as the thermography camera 14 and installed above the modeling stage 12.

The size of the modeling stage 12 made of aluminum was 500 mm×500 mm×10 mm.

As the heater unit 16, two planar heaters (SAKAGUCHI E.H VOC CORP., SAMICON SUPER 34011) each having a size of 150 mm×380 mm, were attached to a back surface of the modeling stage 12.

Before the first example, a time period for stabilizing the temperature of the surface of the modeling stage 12 was confirmed.

Specifically, a surface temperature of a central portion of the modeling stage was set to 143° C., a change over time in the surface temperature of the central portion was measured, and the actual temperature of the modeling stage 12 was 140° C. However, it was found that it took approximately 20 minutes to stabilize the surface temperature to the set temperature. Therefore, the surface temperature was evaluated after 30 minutes elapsed after the start of heating.

The total area of the two heaters was 300 mm×380 mm and was divided into 30×38 sections, each of which was a square of 1 cm×1 cm, and a temperature distribution of temperature, which was measured by the thermography camera 14, of the surface of the modeling stage 12 was schematically shown in degrees. First, the feedback control was performed by the controller 40 so that the temperature, which was measured by the thermography camera 14, of a standard measurement point set at the central portion of the modeling stage 12 was 140° C.

Measured temperature of the surface of the modeling stage 12 is described below.

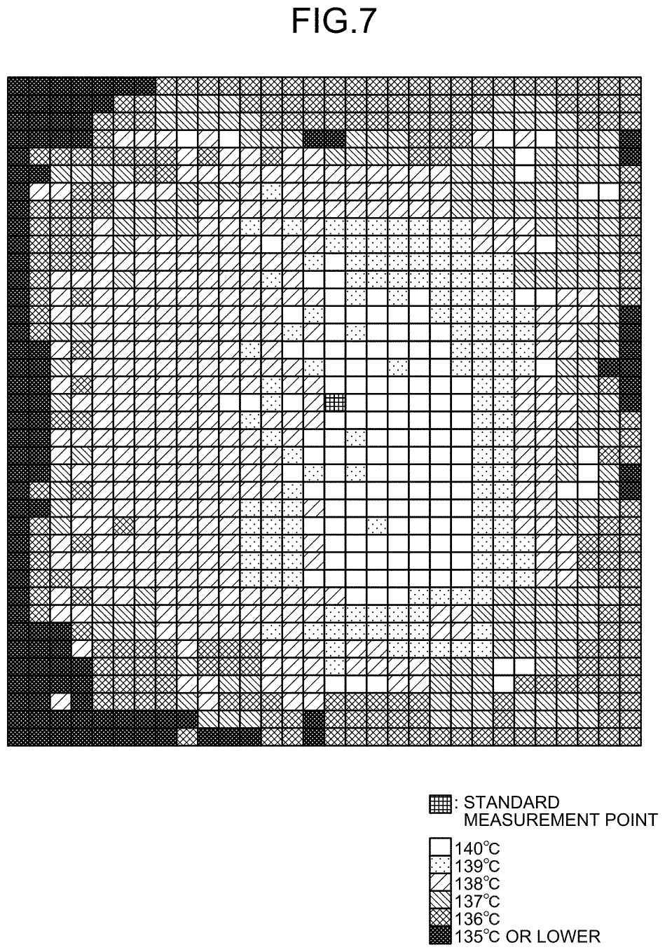

FIG. 7 is a diagram illustrating the case where the surface temperature distribution of the modeling stage is controlled based on the temperature of the standard measurement point set at the center.

FIG. 7 illustrates temperatures of the measured sections when a set temperature associated with a modeling material is 140° C. and the temperature of the standard measurement point is equal to 140° C.

It is found that, when the modeling stage 12 including the heater unit 16 with the two planar heaters having the large total area is controlled based on the temperature of the standard measurement point set at the center, the temperature of the entire surface cannot be accurately managed. In particular, it was confirmed that temperatures at ends of the modeling stage deviated from the temperature of the standard measurement point. In addition, it is found that the difference between the two planar heaters (left and right planar heaters) forming the heater unit 16 affects the temperature of the surface.

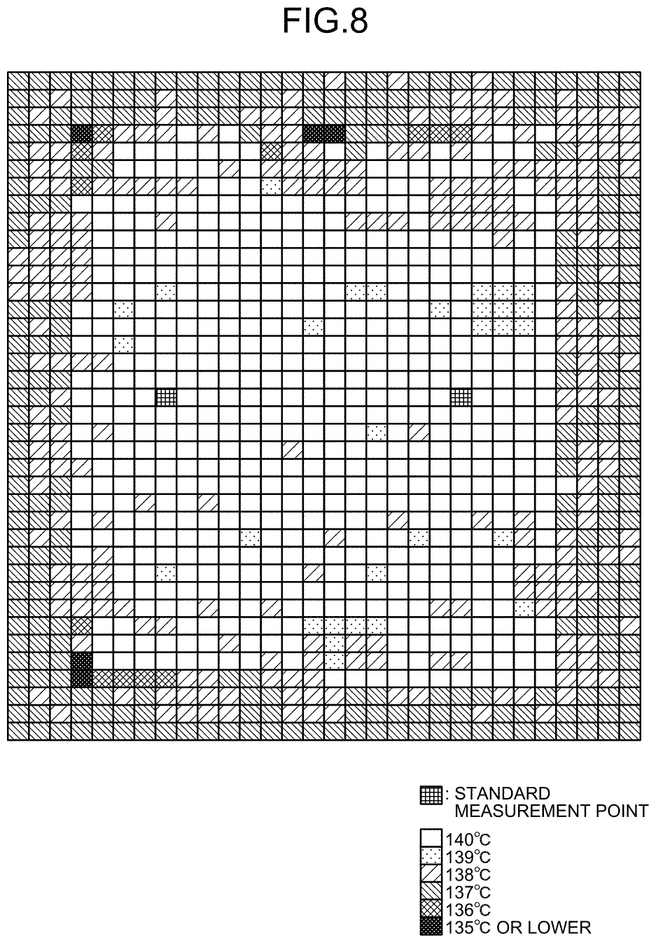

FIG. 8 is a diagram illustrating the case where the surface temperature distribution of the modeling stage is controlled based on temperatures of two standard measurement points set at the centers of the two heaters forming the heater unit.

Next, the case where the feedback control is performed by the controller 40 so that temperatures, which are measured by the thermography camera 14, of the positions of the centers of the heaters are equal to each other is described.

In this case, the controller 40 uses the thermography camera 14 to measure the standard measurement points corresponding to the planar heaters, calculates deviations from the set temperature, and controls the planar heaters.

As a result, as illustrated in FIG. 8, there was almost no variation caused by the left and right heaters in the temperature of the surface of the modeling stage 12. However, there still remains a variation in temperatures in each of portions that are within the surfaces corresponding to the respective planar heaters.

### Second Example

Next, a second example is described.

In the second example, the size of each of planar heaters attached to the back surface of the modeling stage 12 with the same size as that described in the first example was set to 50 mm×130 mm, the 18 heaters were arranged in 6 columns×3 columns, and the total installation area of the heaters was set to 300 mm×390 mm.

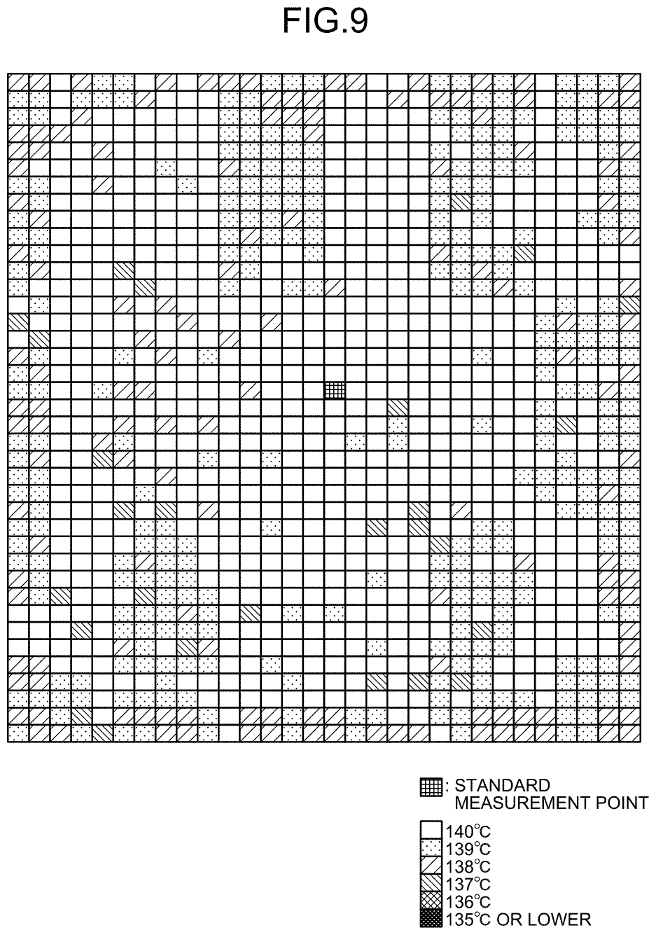

FIG. 9 is a diagram illustrating the case where the heaters according to the second example are used to control the surface temperature distribution of the modeling stage based on the temperature of a single measurement point set at the central portion of the modeling stage.

FIG. 9 illustrates the temperature distribution in the case where the total installation area of the heaters is divided into 30 sections arranged in a horizontal direction×39 sections arranged in a vertical direction. Each of the sections is a square of 1 mm×1 mm.

First, the temperature of the standard measurement point set at the central portion was set to 150° C., and temperatures of the sections were considered based on a measured value of the standard measurement point set at the central portion.

It is found that the temperature of the surface was 143° C. in temperature control in which the thermocouple installed at a central portion of the back surface of the modeling stage was referenced and that an effect of variations in the many arrayed heaters on the temperature of the surface was relatively small. It was considered that the heaters, each having the small area, affected each other to suppress the variations.

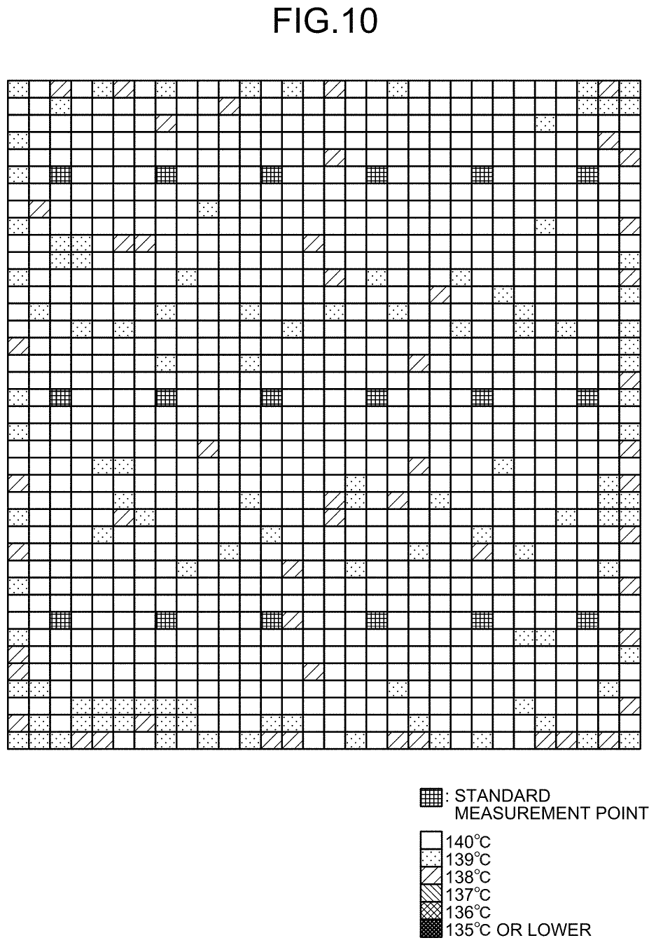

FIG. 10 is a diagram illustrating results of performing the feedback control on the surface temperature distribution of the modeling stage using the heaters according to the second example based on temperatures of a plurality of standard measurement points set at central portions of the heaters.

As a result of the feedback control that was performed by the controller 40 so that the temperatures, which were measured by the thermography camera, of the positions of the centers of the heaters were equal to each other, there was almost no variation in the heaters, as illustrated in FIG. 10. In addition, a decrease in temperatures of outer edges of heaters arranged at the outermost circumference was almost not confirmed.

In addition, the same procedure was performed on what is called other super engineering plastic, that is, polyphenylene sulfide, polysulfone, polyether sulfone, polyetherimide, polyamideimide, and polyphenyl sulfone, and optimal temperature of the surface of the modeling stage was calculated. Then, a mechanism inputs the optimal temperature to the storage section of the apparatus and automatically adjusts temperature of the surface of the modeling stage to an optimal temperature every time a material is changed. The modeling object was modeled on the modeling stage with the surface whose temperature was controlled as illustrated in FIG. 10. Therefore, even when any one of the foregoing materials illustrated in FIG. 5 is used, the amount of bending can be suppressed to a very small amount by controlling the temperature to the optimal temperature in large-scale and large-area modeling.

### Comparative Example

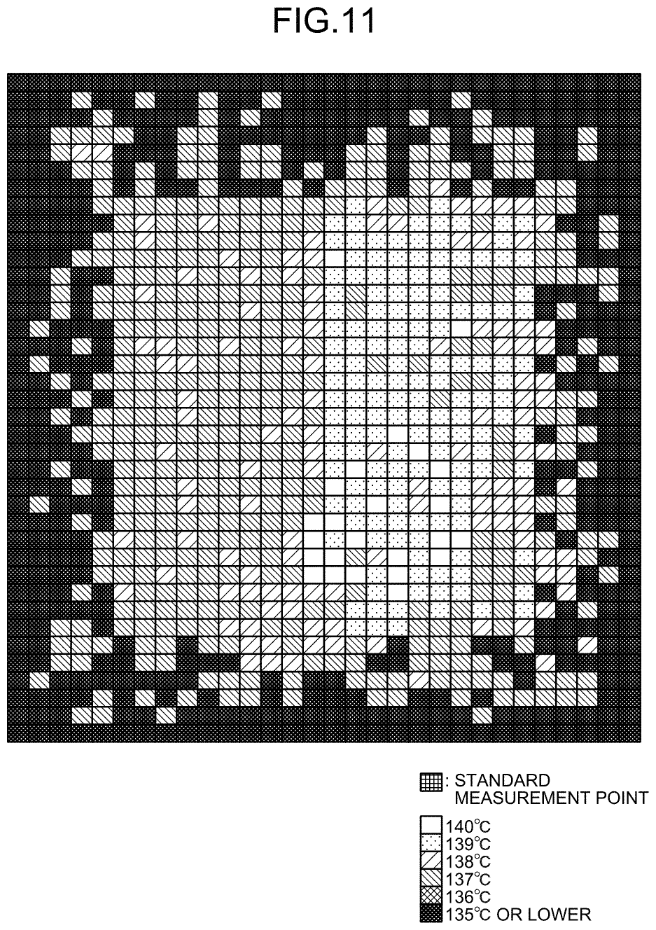

FIG. 11 is a diagram illustrating the case where the heaters according to the first example are used to control the surface temperature distribution of the modeling stage based on the temperature of the single standard measurement point set at the central portion of the modeling stage.

The thermocouple installed at the central portion of the back surface of the modeling stage 12 was referenced and a surface temperature of the central portion of the modeling stage 12 was controlled. The surface temperature, however, were not able to be accurately controlled and varied within a range of approximately 2° C. to 3° C. for each evaluation.

FIG. 11 indicates a comparative example in which the surface temperature of the central portion of the modeling stage 12 was 138° C.

In the comparative example, temperature of the peripheral portion is relatively largely distributed, and the three-dimensional modeling object MO was bent and was not appropriately modeled.

According to an embodiment, an effect of obtaining a high-quality three-dimensional modeling object using a simple configuration while suppressing bending and deformation of the three-dimensional modeling object is exerted.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A modeling apparatus comprising:
a modeling section configured to model a modeling layer with a modeling material on a modeling stage; and
a temperature distribution controller configured to control a surface temperature distribution of the modeling stage within a predetermined temperature range associated with the modeling material based on the surface temperature distribution of the modeling stage.

2. The modeling apparatus according to claim 1, wherein
the temperature distribution controller includes:
a surface temperature distribution measurer configured to measure the surface temperature distribution of the modeling stage,
a heating section configured to heat the modeling stage, and
a controller configured to control the heating section based on the surface temperature distribution and control the surface temperature distribution of the modeling stage within the predetermined temperature range.

3. The modeling apparatus according to claim 2, wherein the surface temperature distribution measurer includes a thermography camera.

4. The modeling apparatus according to claim 2, wherein the heating section includes a plurality of planar heaters.

5. The modeling apparatus according to claim 4, wherein the controller is configured to perform feedback control on each of the plurality of planar heaters based on the surface temperature distribution of the modeling stage.

6. The modeling apparatus according to claim 2, wherein
the controller includes a storage section configured to store a surface temperature of the modeling stage, the surface temperature being suitable for the modeling material, so that the surface temperature is associated with the modeling material, and
the controller is configured to reference the storage section and perform control to within the set predetermined temperature range associated with the modeling material.

7. The modeling apparatus according to claim 1, wherein the modeling material includes thermoplastic resin and includes at least one type selected from among polyphenylene sulfide, polysulfone, polyether sulfone, polyetherimide, polyamideimide, polyetheretherketone, and polyphenyl sulfone.

8. A method performed by a modeling apparatus including a modeling section configured to model a modeling layer with a modeling material on a modeling stage, and a heating section configured to heat the modeling stage, the method comprising:
measuring a surface temperature distribution of the modeling stage; and
controlling the heating section based on the surface temperature distribution and controlling the surface temperature distribution of the modeling stage within a predetermined temperature range associated with the modeling material.

9. A computer program product comprising a non-transitory computer-readable medium including programmed instructions that cause a computer to control a modeling apparatus including a modeling section configured to model a modeling layer with a modeling material on a modeling stage, and a heating section configured to heat the modeling stage, and cause the computer to function as:
a section configured to measure a surface temperature distribution of the modeling stage; and
a section configured to control the heating section based on the surface temperature distribution and control the surface temperature distribution of the modeling stage within a predetermined temperature range associated with the modeling material.
